(19) United States
(12) Patent Application Publication
(10) Pub. No.: US 2010/0253956 A1
(43) Pub. Date: Oct. 7, 2010

(54) IMAGE FORMING APPARATUS AND CONTROLLING METHOD OF THE SAME

(75) Inventors: Tadashi Kobayashi, Okaya-shi (JP); Hiroshi Nakazato, Shiojiri-shi (JP); Kazuyuki Ogo, Azumino-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/752,046

(22) Filed: Mar. 31, 2010

(30) Foreign Application Priority Data
Apr. 2, 2009 (JP) 2009-090045

(51) Int. Cl. H04N 1/60

(52) U.S. Cl. 358/1.9

(57) ABSTRACT

An image forming apparatus includes a controller section that executes image processing on data of an image to be outputted, and a printing execution unit that forms the image on a printing medium on the basis of the image-processed output data transferred from the controller section; the controller section including a color-material counting section that measures the quantities in which the respective color materials of the plurality of colors are consumed on the basis of the output data; and a determination section that acquires the measured values from the color-material counting section for each output unit, and determining that printing was conducted in color for the output unit when the measured values of the color materials other than the black color material have changed and that printing was conducted in monochrome for the output unit when the measured value of the black color material alone has changed.

### BACKGROUND

1. Technical Field

The present invention relates to an image forming apparatus for determining whether an outputted image has been printed in color or monochrome and storing the determination result, or specifically to an image forming apparatus capable of making such a determination according to the output state of the image.

2. Related Art

In existing image forming apparatuses such as printers and copying machines which can perform printing in color and monochrome, the numbers of outputted color and monochrome pages are counted respectively and stored as information for maintenance and also for charging users.

It shall be determined whether an outputted page has been printed in color or monochrome for counting and storing the numbers of outputted pages in respective printing states. One of existing methods for this type of determination may be found in some printers, in which the printer driver of the host device that issues a printing command makes the determination. More specifically, the printer driver makes a color/monochrome determination for each of printed pages on the basis of data received from the application of a print requester and incorporates the determination result into a command to be transmitted to the printer. The printer then determines whether the outputted page is a color or monochrome page from the command.

Another existing method makes a color/monochrome determination on the basis of presence or absence of data of colors used for color printing by checking the bitmap data of the image formed before the printing process is executed by the printer or the like. In an ordinary printer capable of printing color images, bitmap data (image data) with each pixel containing density gradation values of respective colors of the color materials used for printing (such as toners) are generated and retained. When four color materials of CMYK are used for printing, for example, four sets of bitmap data for C, M, Y and K are generated for a page to be printed. When the bitmap data have been generated for one of C, M and Y used for color printing, the printed page is determined to be a color page. If no bitmap data have been generated for any of C, M and Y, the page is determined to be a monochrome page. Japanese Patent No. 2985963 discloses a method for calculating the status of use of toners on the basis of page dot data.

In the above-mentioned method for performing determination with the printer driver, however, the determination is made upon reception of data from the application. Since overlap of image objects cannot be detected at such a timing, a page with color data included in the received data is determined to be a color page. Even if color data have been completely overwritten by monochrome data and the page ultimately has only monochrome images, it is determined to be a color page. Therefore, a problem of the method is an improper determination that does not correspond to actual output, thus making the method unsuitable to be used for charging users, in particular.

In addition, the above-mentioned method for detecting the presence of bitmap data cannot be used in some cases. Some types of printers may generate and retain bitmap data in a color space different from that of the above-mentioned color materials in order to enhance performance of the process. For example, when CMYK color materials are used and bitmap data are created in RGB, the bitmap data may be color-converted to CMYK during the process of data transfer to the printing execution unit. In such a case, color/monochrome determination cannot be properly made merely on the basis of presence or absence of color data in the bitmap data.

### SUMMARY

An advantage of some aspects of the invention is that it provides an image forming apparatus for determining whether an outputted image has been printed in color or monochrome and storing the determination result, or specifically an image forming apparatus capable of making such determination according to the output state of the image.

According to an aspect of the invention, an image forming apparatus is provided which can perform printing using a plurality of color materials including a black color material and includes a controller section for executing image processing on data of an image to be outputted and a printing execution unit for forming the image on a printing medium on the basis of the image-processed output data transferred from the controller section. The controller section includes a color-material counting section for measuring the quantities in which the respective color materials of the plurality of colors are consumed on the basis of the output data, and a determination section for acquiring the measured values from the color-material counting section for each specified output unit. The determination section also determines that printing was conducted in color for the specified output unit when the measured values of the color materials other than the black color material have changed and that printing was conducted in monochrome for the specified output unit when the measured value of the black color material alone has changed.

The image forming apparatus according to the aspect of the invention preferably further includes a memory section for storing the number of specified output units printed in color and the number of specified output units printed in monochrome, with the stored numbers of specified output units being updated on the basis of the result of determination made by the determination section.

In the image forming apparatus according to the aspect of the invention, the output data is preferably data showing an ON or OFF status of the operation conducted for image forming by the printing execution unit.

In the image forming apparatus according to the aspect of the invention, the determination made by the determination section is preferably performed after the printed medium has been outputted following the formation of images on the specified output units.

In the image forming apparatus according to the aspect of the invention, the specified output unit is preferably a single page of the printed medium.

According to another aspect of the invention, a method for controlling an image forming apparatus is provided, the image forming apparatus being capable of printing using a plurality of color materials and including a black color material and having a controller section for performing image processing on data of an image to be outputted and a printing execution unit for forming the image on a printing medium on the basis of the image-processed output data transferred from the controller section. The method includes counting the quantities of the color materials by measuring the quantities in which the respective color materials of the plurality of colors are consumed on the basis of the output data, and making a determination by acquiring values measured in the color-material counting section for each specified output unit, and determining that printing was conducted in color for the specified output unit when the measured values of the color materials other than the black color material have changed and that printing was conducted in monochrome for the specified output unit when the measured value of the black color material alone has changed.

According to yet another aspect of the invention, an image forming apparatus is provided which can perform printing using a plurality of color materials including a black color material and which has a controller section for executing image processing on data of an image to be outputted and a printing execution unit for forming the image on a printing medium on the basis of the image-processed output data transferred from the controller section. The quantities in which the respective color materials of the plurality of colors are consumed is measured on the basis of the output data, and a control program of the image forming apparatus acquires the measured values of the quantities of the respective color materials consumed. The control program determines that printing was conducted in color for the specified output unit when the measured values of the color materials other than the black color material have changed and that printing was conducted in monochrome for the specified output unit when the measured value of the black color material alone has changed.

Further objects and features of the invention will become apparent from aspects of the invention described below.

### BRIEF DESCRIPTION OF THE DRAWINGS

The invention will be described with reference to the accompanying drawings, wherein like numbers reference like elements.

FIG. 1 is a configuration diagram of an embodiment of the printer, or the image forming apparatus, according to an aspect of the invention.

FIG. 2 is a flow chart illustrating the procedure of the printing process of a single page executed by the printer 2.

FIG. 3 is a diagram illustrating the case of a color printing job in which one of the pages to be printed is a monochrome page.

### DESCRIPTION OF EXEMPLARY EMBODIMENTS

The embodiments of the invention will be described with reference to the accompanying drawings. The scope of the invention, however, may not be limited by the aspects mentioned below. Like numbers reference like elements in the figures.

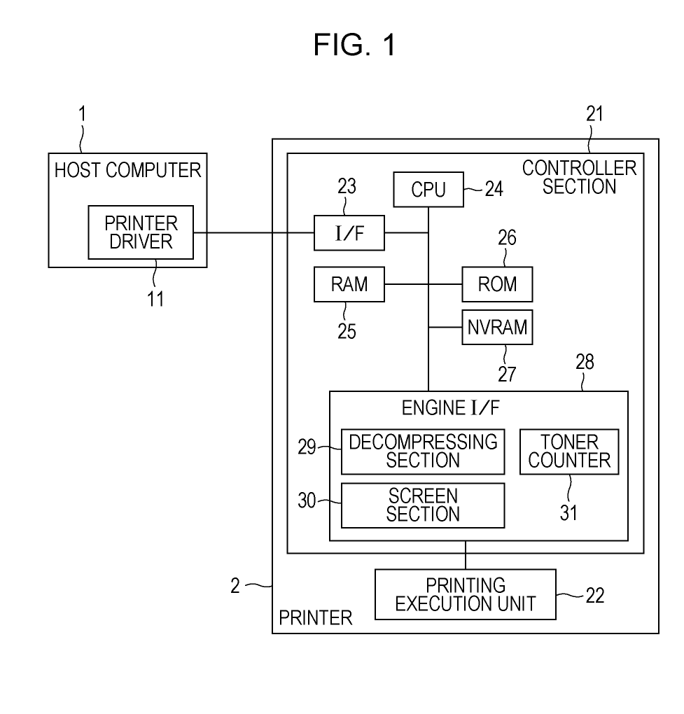

FIG. 1 is a configuration diagram of an embodiment of the printer, or the image forming apparatus, according to an aspect of the invention. The printer 2 shown in FIG. 1 is a printing apparatus to which aspects of the invention are applied. The printer 2 is adopted to make a determination whether a printed page is printed in color or monochrome on the basis of the counted quantities of respective color materials consumed according to output data after screen processing to be outputted to a printing execution unit 22 (engine), or on the basis of the value of a toner counter 31, and to make appropriate color/monochrome determination according to the outputted result.

A host computer 1 shown in FIG. 1 is a host device for making a request for printing to the printer 2 and includes a personal computer or the like. The host computer 1 also includes a printer driver 11, which generates printing data containing image data and control command according to user operation upon receiving a printing request and transmits the printing data to the printer 2. In this aspect, data transmitted from the printer driver 11 to the printer 2 is written in PDL (page-description language). The printer driver 11 may contain a program for executing the printing process and a controller unit (not shown) for the host computer 1 for executing the printing process according to the program.

As shown in FIG. 1, the printer 2 is a printing device including a controller section 21 and the printing execution unit 22 and is a laser printer as an example in this aspect.

The controller section 21 controls the process of receiving the printing request from the host computer 1 and transmitting a printing instruction to the printing execution unit 22 and includes an I/F 23, a CPU 24, a RAM 25, a ROM 26, an NVRAM 27 and an engine I/F 28 as shown in FIG. 1.

The I/F 23 is a section for receiving the printing data transmitted by the host computer 1.

The CPU 24 is a section for controlling various processing operations executed in the controller section 21. When receiving a printing request from the host computer 1, the CPU 24 controls the processing of performing specified image processing on image data contained in the received printing data to generate bitmap data (image data) and the processing of interpreting the control command contained in the printing data to instruct appropriate printing processing to the printing execution unit 22.

The CPU 24 also executes processing of making a determination whether each of pages has been printed in color or monochrome in the course of processing of printed pages and updates information on the number of outputted pages to be stored in an NVRAM 27, to be mentioned below, on the basis of the determination result. The printer 2 is characterized by the processing, and specific details of the processing are described below. The processing executed by the CPU 24 is performed according to a program stored in the ROM 26.

The RAM 25 is a memory for temporarily storing received printing data and image data after processing and also stores bitmap data (image data) of the respective colors.

The ROM 26 is a memory for storing programs for performing various processing operations to be executed by the CPU 24.

The NVRAM 27 is a non-volatile memory for storing various configurations and history information required to be retained even when the power of the printer 2 is turned off. Information stored includes the number of outputted pages and, more specifically, the number of pages outputted in color printing and the number of pages outputted in monochrome printing. The number of blank pages outputted is also stored.

In executing a printing process with the printing execution unit 22, the engine I/F 28 executes processing of reading out the bitmap data stored in the RAM 25 at a specified timing, executing specified processing and transferring the data to the printing execution unit 22. The engine I/F 28 includes a decompressing section 29, a screen section 30 and a toner counter 31 as shown in FIG. 1.

Since the bitmap data have been compressed before being stored in the RAM 25, the decompressing section 29 executes processing to decompress the read-out bitmap data. The screen section 30 is a section for executing so-called screen processing on the decompressed bitmap data. Output data showing an on/off state of laser radiation at the printing execution unit 22 are then generated and transferred to the printing execution unit 22.

In the printer 2, four color materials (or toners) of C (cyan), M (magenta), Y (yellow) and K (black) are used for printing onto a printing medium, and bitmap data are generated for each of the C, M, Y and K colors. The bitmap data may be generated with R (red), G (green) and B (blue), in which case a color conversion section (not shown) is provided in the engine I/F 28 for executing color conversion processing to CMYK after the decompression.

The toner counter 31 is a section for counting the amounts of the toners of respective colors used, or CMYK, and counts the amounts on the basis of the output data fed to the printing execution unit 22 for the respective colors. The engine I/F 28 may specifically be configured with ASIC.

The printing execution unit 22 includes a mechanical controller and a printing mechanism, both of which are not shown. The printing mechanism includes a photoreceptor drum, a charging unit, an exposure unit, a developing unit, and a transfer unit, all of which are not shown. In execution of printing, the charging unit charges the photoreceptor drum, and the exposure unit irradiates a beam from a light source such as a built-in laser or LED array onto the charged photoreceptor drum to form an electrostatic latent image. Then the developing unit incorporating toner cartridges holding developers (toners) develops the latent image into an image using the developers, and the transfer unit transfers the developed toner image onto a printing medium such as a piece of paper. Then the image on the printing medium is fixed by a fixing unit, and the printing medium is ejected out of the printer 2.

The printing execution unit 22 is provided with a sensor for detecting ejection of the printing medium after printing processing, and the ejection of the printed page is notified to the controller section 21.

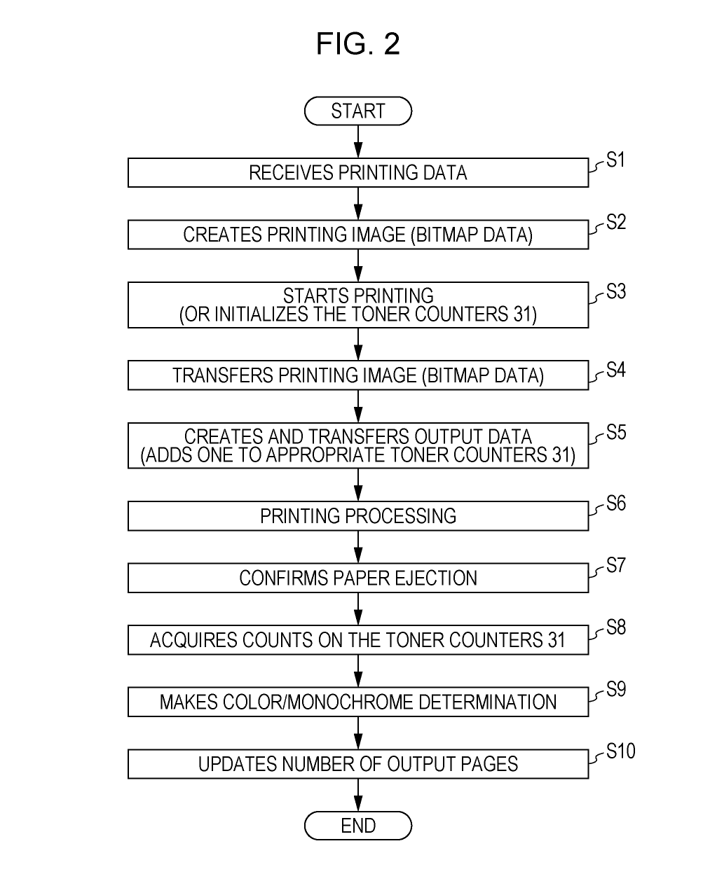

The printer 2 having the above-mentioned structure is characterized by its color/monochrome determination in the printing processing as mentioned earlier. The specific details of the printing process including the determination process are described below. FIG. 2 is a flow chart illustrating the procedure of the printing process executed by the printer 2 for printing a single page.

First, the above-mentioned printing data are transmitted from the printer driver 11 of the host computer 1 and received by the controller section 21 of the printer 2 (Step S1). More specifically, the printing data written in PDL are received via the I/F 23 and stored in a reception buffer of the RAM 25.

Then the controller section 21 generates bitmap data (image to be printed) of the respective colors for the page to be printed on the basis of the received printing data (Step S2). This step is executed by the CPU 24. More specifically, the control command contained in the printing data is first interpreted. Then, a development process or a process to generate bitmap data is executed on the image data contained in the printing data according to the interpretation. When the image data are expressed in RGB, for example, bitmap data are generated with pixels respectively having density gradation values of each color of R, G and B, and then a color conversion process is executed to generate bitmap data with pixels respectively having density gradation values of each color of C, M, Y and K. Thus-generated bitmap data are compressed and stored in an image buffer (band buffer) of the RAM 25.

In the generation process of the bitmap data, a single page is divided into a plurality of regions respectively called bands, and the process is sequentially executed band by band. Thus-generated bitmap data of the single page are retained as plain data of each of C, M, Y and K colors.

As mentioned earlier, RGB bitmap data may be compressed and retained when the color conversion processing to CMYK is later executed by the engine I/F 28.

When bitmap data of a single page is thus generated, the CPU 24 transmits a printing start request for the page to the printing execution unit 22 (Step S3). Furthermore, the CPU 24 initializes the above-mentioned toner counters 31 of the respective colors at this point, or resets the counters to zero. On receiving the printing start request, the printing execution unit 22 starts a printing operation and generates a synchronization signal. Then the controller section 21 receives the synchronization signal and starts data transfer as described below.

The engine I/F 28 requests transfer of the bitmap data band by band as mentioned above and transfers the bitmap data from the RAM 25 to the engine I/F 28 (Step S4) according to the setting by the CPU 24. The transfer processing (S4) and the processing by the engine I/F 28 (S5) to be mentioned below are executed for all data of a single page per band and in the order of the bands. In this aspect of the invention, it is assumed that a so-called four-cycle laser printer is being used, and thus processing is executed for each color in the order of C, M, Y and K. After processing of one color for the single page is completed, processing of a second color starts.

The engine I/F 28 then generates output data mentioned earlier from the transferred and compressed bitmap data, and sequentially executes processing of data transfer to the printing execution unit 22 (Step S5). More specifically, the decompressing section 29 decompresses the bitmap data, and the screen section 30 subsequently executes screen processing. Then, the above-mentioned output data are generated and transferred.

In the course of the processing, the toner counters 31 of the respective colors count (or measure) the quantities of the respective toners consumed (C, M, Y and K in this aspect). The counting of these quantities is performed on the basis of the above-mentioned transferred output data of the respective colors, and more specifically, the output data or the data representing the ON/OFF state are detected at the specified clock frequency, and the number of ON states is counted. In the processing, for each color used on a single page, the amount of color used is counted, and a higher number means that more toner of the color has been consumed. A count of zero shows that the toner of the color has not been used for the page.

When the bitmap data are stored with RGB and color-converted by the engine I/F 28, output data are also transferred to the printing execution unit 22 in a similar manner, and the quantities of the toners consumed are also counted in a similar manner.

When the output data are fed to the printing execution unit 22, the printing execution unit 22 sequentially executes the printing processing as mentioned earlier (Step S6).

When the printing processing of the page on the printing medium is completed and the printing medium is ejected, the above-mentioned ejection sensor detects the ejection and the ejection of the page is notified to the controller section 21. Upon notification of ejection, the CPU 24 confirms the ejection of the processed page (Step S7) and acquires the counts from the respective toner counters 31 at this point in time (Step S8).

Then the CPU 24 determines whether the processed page was in color or monochrome on the basis of the acquired counts (Step S9). More specifically, when an acquired count is zero, it is determined that the toner of the color has not been consumed. When the acquired count is not zero, the toner is determined to have been consumed. When an acquired count of any of the colors other than black is not zero, the processed page is determined to be in color. In other words, when an acquired count of any of C, M and Y is not zero, the processed page is determined to be in color. On the other hand, when acquired counts of all the colors other than black are zero, the processed page is determined to be in monochrome or the page is blank. In other words, in the case that all the counts of C, M and Y are zero, the processed page is determined to be in monochrome or the page is blank. When the count of black (or K) is also zero, the page is determined as blank. When the count of black (or K) alone is not zero, the printing is determined to be in monochrome.

In the final step, the CPU 24 updates the number of output pages stored in NVRAM 27 on the basis of the determination result. More specifically, when the page is determined to be a color page, the CPU 24 adds one to the number of output pages in color printing. When the page is determined to be a monochrome page, the CPU 24 adds one to the number of output pages in monochrome printing. When the page is determined to be blank, the CPU 24 adds one to the number of blank output pages. The output of blank pages occurs when only white images exist, when all images are overwritten by white images, or when no image exists within the output area due to an offset of the print range.

The processing of a single page is thus completed, while the information on the number of updated output pages will be utilized for maintenance of the printer 2 or charging users.

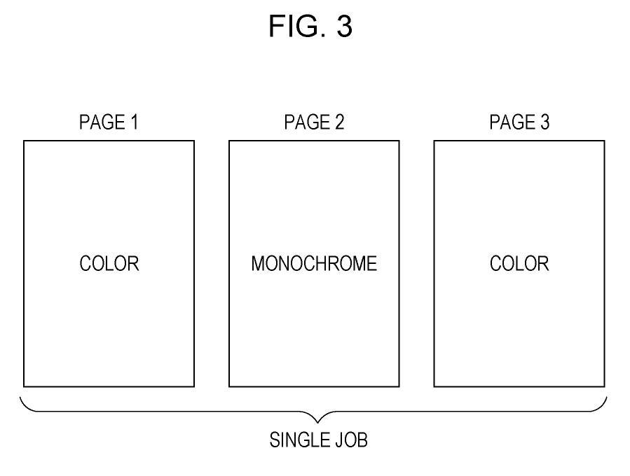

FIG. 3 is a diagram illustrating the case of a printing job of color printing containing a monochrome page. In the printing job in which three pages are outputted shown in FIG. 3, original color images are overwritten by monochrome images on page 2. In the determination performed by the above-mentioned existing printer driver, the page should be determined to be a color page. Thus the printer driver determines that three pages in color have been printed in color in this printing job and updates the number of output pages according to the determination.

According to determination by the printer 2, on the other hand, K data alone are counted among the output data of page 2, and the page is determined to be in monochrome. Thus, the number of output pages is updated to add two pages of color printing and a page of monochrome printing for the printing job.

As in the foregoing description, the printer 2 in accordance with an aspect of the invention makes a determination as to whether a page has been printed in color or monochrome on the basis of information of toner consumption counted according to data ultimately outputted to the printing execution unit 22 (engine). Thus appropriate determination according to actual output state may be made. Therefore, information on the number of output pages becomes more accurate by using the printer 2, thus attaining more precise maintenance and charging on the basis of the information. When the output is charged to a user on the basis of the information, in particular, the charged amount matches the quantity of the output and results in no complaints from the user.

Furthermore, the printer 2 may make similar color/monochrome determination even when the bitmap data retained before the start of printing (S3) are created with RGB or when the data are not expressed with the same color space as the color materials used for printing.

Furthermore, the printer 2 makes a color/monochrome determination and updates the number of output pages on the basis of the determination after ejection of the page has been confirmed. Therefore, if the page is not ultimately ejected due to an error such as a paper jam even after the data are transferred to the printing execution unit 22 and printing processing is started, the number of the output page remains unchanged. Improper charging of pages, which have not actually been outputted, may be prevented.

While the image forming apparatus according to an aspect of the invention is a printer in the above description, the invention may be applied to a copying machine or the like.

The scope of the invention is not limited to the above-mentioned aspects of the invention and may cover the aspects set forth in the scope of invention and their equivalents.

The entire disclosure of Japanese Patent Application No. 2009-090045, filed Apr. 2, 2009 is expressly incorporated by reference herein.

What is claimed is:

1. An image forming apparatus which can perform printing using a plurality of color materials including a black color material comprising: a controller section that executes image processing on data of an image to be outputted; and a printing execution unit that forms the image on a printing medium on the basis of the image-processed output data transferred from the controller section;
the controller section comprising:
a color-material counting section that measures the quantities in which the respective color materials of the plurality of colors are consumed on the basis of the output data; and
a determination section that acquires the measured values from the color-material counting section for each specified output unit, and determining that printing was conducted in color for the specified output unit when the measured values of the color materials other than the black color material have changed and that printing was conducted in monochrome for the specified output unit when the measured value of the black color material alone has changed.

2. The image forming apparatus according to claim 1, further comprising:
a memory section that stores the number of specified output units printed in color and the number of specified output units printed in monochrome;
wherein the stored numbers of specified output units are updated on the basis of the result of determination made by the determination section.

3. The image forming apparatus according to claim 1,
wherein the output data are data showing an ON or OFF status of the operation conducted for forming images by the printing execution unit.

4. The image forming apparatus according to claim 1,
wherein the determination by the determination section is conducted after the printed medium is outputted after the formation of images on the specified output units.

5. The image forming apparatus according to claim 1,
wherein a specified output unit is a single page of the printed medium.

6. A method for controlling an image forming apparatus which can perform printing using a plurality of color materials including a black color material having a controller section for executing image processing on data of an image to be outputted, and a printing execution unit for forming the image on a printing medium on the basis of the image-processed output data transferred from the controller section comprising:
counting the color materials by measuring the quantities in which the respective color materials of the plurality of colors are consumed on the basis of the output data; and
making a determination by acquiring values measured in the color-material counting for each specified output unit, and determining that printing was conducted in color for the specified output unit when the measured values of the color materials other than the black color material have changed and that printing was conducted in monochrome for the specified output unit when the measured value of the black color material alone has changed.
